(19) United States
(12) Patent Application Publication
(10) Pub. No.: US 2005/0216122 A1
(43) Pub. Date: Sep. 29, 2005

(54) Self-propelled cleaner

(75) Inventor: Takao Tani, Osaka (JP)

Correspondence Address: Yokoi & Co., U.S.A., Inc.;# 1512, 13700 Marina Pointe Drive, Marina Del Rey, CA, 90292, US

(73) Assignee: Funai Electric Co., Ltd., Osaka (JP)

(21) Appl. No.: 11/073,983

(22) Filed: Mar. 7, 2005

(30) Foreign Application Priority Data
Mar. 25, 2004 (JP) JP2004-089359

(51) Int. Cl. G06F 19/00

(52) U.S. Cl. 700/245; 701/23

(57) ABSTRACT

Conventional nursing support robots, which are intended only for nursing, use complicated equipment. Therefore, they are expensive and it is difficult for them to be popularly used. According to the present invention, when a robot system decides at step S440 that it is time preset on a timer, it calculates a travel route from the standby position to a first cared person's location at step S446 and moves to that location at step S448 and asks the person a question and judges the answer (steps S450 to S458). If the answer is normal, it calculates the travel route from the first cared person's location to the second cared person's at step S446 and moves to the second cared person's location at step S448 and asks a question and judges the answer (steps S450 to S458). If the answer is not normal at a cared person's location, the system compiles nursing data on that person at steps S462 to S466 and transmits it through a wireless LAN at step S468. When the nursing patrol process for all persons to be checked for is finished, the system returns to its original standby position in a hall at step S462.

### BACKGROUND OF THE INVENTION

1. Field of the Invention

This invention relates to a self-propelled cleaner comprising a body with a cleaning mechanism and a drive mechanism capable of steering and driving the cleaner.

2. Description of the Prior Art

The following nursing support robots have been known: a nursing support robot which asks a question, receives an answer and notifies the outside of an abnormality if the answer is not normal, as disclosed in JP-A No. 574/2002 (Patent document 1); and a nursing support robot which transmits information on the appearance of a person to be cared for as an image, as disclosed in JP-A No.234681/1998 (Patent document 2).

Since the above conventional nursing support robots are intended only for nursing, they use complicated equipment. Therefore, they are expensive and it is difficult for them to be popularly used.

### SUMMARY OF THE INVENTION

This invention has been made in view of the abovementioned problem and provides a self-propelled cleaner that is capable of cleaning while traveling by itself and can also be used to support nursing care.

According to one aspect of this invention, the self-propelled cleaner has a body with a cleaning mechanism, and a drive mechanism capable of steering and driving the cleaner. It includes: a mapping processor which stores geographical information on a room to be cleaned; a nursing patrol control processor which, at each predetermined time, controls the drive mechanism based on a cared person's location specified in the geographical information to enable the cleaner to travel from the present position to the cared person; a wireless LAN communication device which can transmit given information to the outside through a wireless LAN; a questioning control processor which asks the cared person a question at a given location, and waits for an answer to the question from the cared person; an answer judgment control processor which judges whether an answer to the question from the cared person is normal or not; and a nursing data transmission control processor which, if the answer is not normal, transmits that information to the outside through the wireless LAN communication device.

The system constructed as above has a drive mechanism capable of steering and driving the cleaner and thus it is possible for the cleaner body to travel by itself and perform cleaning. Furthermore, the mapping processor stores geographical information on a room to be cleaned and at each predetermined time the nursing patrol control processor controls the drive mechanism based on a cared person's location specified in the geographical information to enable the cleaner to travel from the present position to the cared person. At the cared person's location, the questioning control processor asks the cared person a question and waits for an answer to the question from the cared person. The answer judgment control processor judges whether an answer to the question from the cared person is normal or not. If the answer is not normal, the nursing data transmission control processor transmits that information to the outside through the wireless LAN communication device which can transmit given information to the outside.

In other words, when a cleaner with an inherent self-propelling cleaning capability is given information on a cared person's location, it can patrol to check the cared person. By simply adding a questioning function and an answer judgment function, information on the person's condition can be externally sent through a wireless LAN if an answer is not normal. This means that if an abnormality occurs in a person to be cared for, information on it can be sent to a person outside so that necessary measures can be taken.

The self-propelled cleaner travels around a room to acquire geographical information on the room but it is laborious to give positional data on the cared person externally. Therefore, according to another aspect of the invention, the mapping processor may be designed to acquire, from a marker installed in a given place in the room which outputs positional data on a previously specified location, that positional data and add it to the geographical information.

In the system constructed as above, when the marker, which outputs positional data on a previously specified location, at a special position at which the user wishes to set that positional data, the mapping processor acquires the positional data and adds it to the geographical information.

For example, it is possible to specify the location of a cared person as a special position. It is also possible to specify plural locations corresponding to plural cared persons as special positions. Also, the locations of infants may be specified as special positions. If markers are installed at such locations, the cleaner can memorize these locations as the locations of cared persons when it travels by itself and reaches there.

Although the self-propelled cleaner can generate geographical information in various ways, a user interface which enables the user to recognize the geographical information at a glance will require a means to display a map and a means to receive user instructions, and the like. This would be costly and laborious. Besides, while the self-propelled cleaner is generating geographical information, it does not always travel at a user-specified time in a user-specified place. It would be very inconvenient if the user has to wait to give an instruction until the cleaner reaches a desired position. In contrast, when a marker which provides required positional data is installed, positional data can be preset very easily.

If the answer is not normal, a concerned person outside wishes to get more detailed information. According to another aspect of the invention, the cleaner has a camera device for taking a photo of a surrounding area and if the answer is not normal, the nursing data transmission control processor enables the camera device to take a photo and transmits that photo image data to the outside through the wireless LAN communication device.

In the system constructed as above, not only information of the abnormal answer but also the photo image data are transmitted to the outside person so that he/she can make a decision based on the image more adequately.

An example of another effective use of the camera device is as follows. The nursing data transmission control processor detects a skin color area in the photo image data, judges the cared person's health condition from a prepared table of relations between skin color hues and health conditions and transmits information on the result of the judgment to the outside through the wireless LAN communication device.

In the system constructed as above, the nursing data transmission control processor detects a skin color area in the photo image data. The skin color is available in a wide range of hues. Generally the color of the face suggests a health condition. When it is pinkish, it demonstrates a good complexion or good health, and if it is bluish or pale, it suggests a sickness. Therefore, a table which defines the relations between hue ranges and health conditions is prepared in advance and the system identifies to which hue range a detected skin color belongs and reads the health condition corresponding to the identified hue range from the table and sends it as the result of judgment to the outside.

According to another aspect of the invention, the cleaner has a thermosensor capable of measuring a temperature in a non-contact manner and the nursing data transmission control processor enables the thermosensor to measure the temperature of the cared person and transmits the measured temperature to the outside through the wireless LAN communication device.

In the system constructed as above, the nursing data transmission control processor enables the thermosensor capable of measuring a temperature in a non-contact manner to measure the temperature of the cared person and transmits the measured temperature to the outside through the wireless LAN communication device.

There are many types of thermosensors capable of measuring a temperature in a non-contact manner. Even if measurement is not so accurate, such temperature information on the cared person are desired and will used effectively.

Various questioning and answering means are available. According to another aspect of the invention, the questioning control processor issues a question by voice through a speaker and the answer judgment control processor gets an answer spoken by the cared person through a microphone.

Such a voice questioning/answering system is friendly to the cared person if he/she is physically challenged. Here, what answer factor is evaluated for the judgment is not limited to what he/she has spoken; instead, more simply the presence or absence of an answer or the number of answers may be evaluated. For example, if the system asks the cared person to say “yes” twice, misjudgment is less likely to occur.

When the cared person is asleep, it does not mean any abnormality that there is no answer. Therefore, according to one aspect of the invention, if the voice received through the microphone is snoring or sleep-breathing, the answer judgment control processor judges it as a normal answer.

In the system constructed as above, if there is no answer to a question and snoring or sleep-breathing is heard, it is considered as no abnormality with the cared person and no abnormality information is sent to the outside. In this case, an alternative approach is to send a status message to notify that there is no abnormality but no answer is received.

The cleaning mechanism which is incorporated in the body may be of the suction-type or brush-type or combination-type.

The drive mechanism capable of steering and driving the cleaner enables the cleaner to go forward or backward, or turn to the right (clockwise) or to the left (counterclockwise), or spin on the same spot by controlling individually the driving wheels provided at the right and left sides of the body. In this case, auxiliary wheels may be provided, for example, in front and behind the driving wheels. Furthermore, endless belts may be used instead of driving wheels. The number of wheels in the drive mechanism is not limited to two; it may be four, six or more.

According to another aspect of the invention, a self-propelled cleaner has a body with a cleaning mechanism and a drive mechanism with driving wheels at the left and right sides of the body whose rotation can be individually controlled for steering and driving the cleaner. The cleaner comprises: a mapping processor which stores geographical information on a room to be cleaned during traveling around the room for cleaning it and acquires data on the location of a cared person during traveling around the room, from a marker which is installed in a given place in the room and outputs positional data on a previously specified location, and adds it to the geographical information; a nursing patrol control processor which, at each predetermined time, acquires data on the cared person's location specified in the geographical information and controls the drive mechanism to enable the cleaner to travel from the present position to the cared person; a wireless LAN communication device which can transmit given information to the outside through a wireless LAN; a questioning control processor which asks the cared person a question by voice through a speaker when the cared person is reached under the control of the nursing patrol control processor, and waits for an answer to the question from the cared person; an answer judgment control processor which receives a spoken answer to the question from the cared person through a microphone and judges whether it is normal or not; and a nursing data transmission control processor which, if the answer is not normal, transmits that information to the outside through the wireless LAN communication device.

In the system constructed as above, the mapping processor stores geographical information on a room to be cleaned during traveling around the room and acquires data on the location of a cared person from a marker which is installed in a given place in the room and outputs positional data on a previously specified location, and adds the data to the geographical information. At each predetermined time, the nursing patrol control processor acquires data on the cared person's location specified in the geographical information and controls the drive mechanism to enable the cleaner to travel from the present position to the cared person. When the cleaner reaches the cared person's location in this way, the questioning control processor asks the cared person a question by voice through a speaker and waits for an answer to the question from the cared person. The answer judgment control processor receives a spoken answer to the question from the cared person through a microphone and judges whether the answer is normal or not. If the answer is not normal, the nursing data transmission control processor transmits that information to the outside through the wireless LAN communication device.

Taking full advantage of the special feature as a self-propelled machine, it is possible to check the condition of a cared person and notify a person outside of it without the need for many additional components.

### BRIEF DESCRIPTION OF THE DRAWINGS

FIG. 1 is a block diagram schematically showing the construction of a self-propelled cleaner according to this invention;

FIG. 2 is a more detailed block diagram of the self-propelled cleaner;

FIG. 3 is a block diagram of a passive sensor for AF;

FIG. 4 illustrates the position of a floor relative to the AF passive sensor and how ranging distance changes when the AF passive sensor is oriented downward obliquely toward the floor;

FIG. 5 illustrates the ranging distance in the imaging range when an AF passive sensor for the immediate vicinity is oriented downward obliquely toward the floor;

FIG. 6 illustrates the positions and ranging distances of individual AF passive sensors;

FIG. 7 is a flowchart showing a travel control process;

FIG. 8 is a flowchart showing a cleaning travel process;

FIG. 9 shows a travel route in a room;

FIG. 10 shows the composition of an optional unit;

FIG. 11 shows the external appearance of a marker;

FIG. 12 is a flowchart showing a mapping process;

FIG. 13 illustrates how mapping is done;

FIG. 14 illustrates how geographical information on each room is linked after mapping;

FIG. 15 shows a screen whereby the user can specify patrol times and cared persons to be checked;

FIG. 16 is a flowchart showing a nursing patrol process; and

FIG. 17 is a plan view showing a room-to-room nursing patrol route.

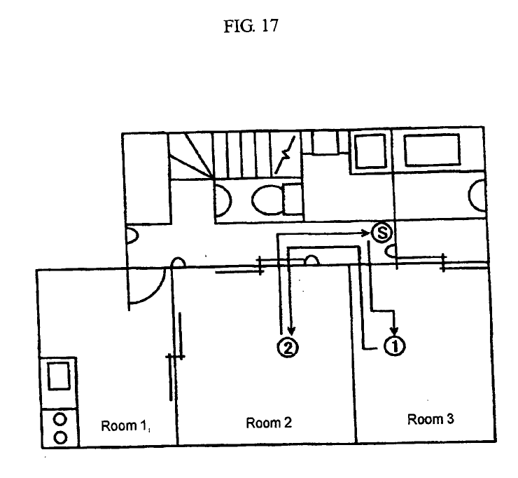

### DESCRIPTION OF THE PREFERRED EMBODIMENTS

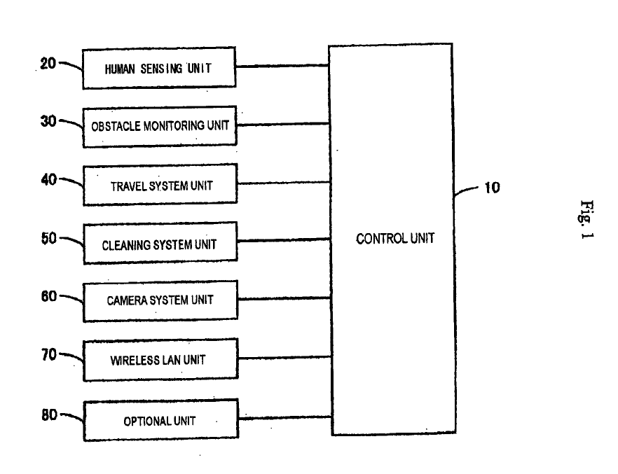

As shown in FIG. 1, according to this invention, the cleaner includes a control unit 10 to control individual units; a human sensing unit 20 to detect a human or humans around the cleaner; an obstacle monitoring unit 30 to detect an obstacle or obstacles around the cleaner; a traveling system unit 40 for traveling; a cleaning system unit 50 for cleaning; a camera system unit 60 to take a photo of a given area; a wireless LAN unit 70 for wireless connection to a LAN; and an optional unit 80 including an additional sensor and the like. The body of the cleaner has a low profile and is almost cylindrical.

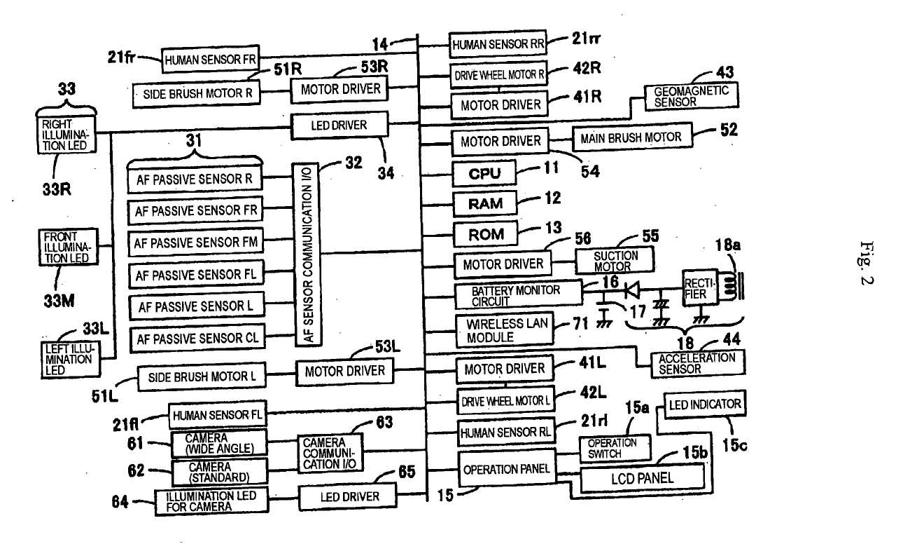

As shown in FIG. 2, a block diagram showing the electrical system configuration for the individual units, a CPU 11, a ROM 13, and a RAM 12 are interconnected via a bus 14 to constitute a control unit 10. The CPU 11 performs various control tasks using the RAM 12 as a work area according to a control program stored in the ROM 13 and various parameter tables. The control program will be described later in detail.

The bus 14 is equipped with an operation panel 15 on which various types of operation switches 15a, a liquid crystal display panel 15b, and LED indicators 15c are provided. Although the liquid crystal display panel is a monochrome liquid crystal panel with a multi-tone display function, a color liquid crystal panel or the like may also be used.

This self-propelled cleaner has a battery 17 and allows the CPU 11 to monitor the remaining amount of the battery 17 through a battery monitor circuit 16. The battery 17 is equipped with a charge circuit 18 that charges the battery with electric power supplied in a non-contact manner through an induction coil 18a. The battery monitor circuit 16 mainly monitors the voltage of the battery 17 to detect its remaining amount.

The human sensing unit 20 consists of four human sensors 21 (21fr, 21rr, 21fl, 21rl), two of which are disposed obliquely at the left and right sides of the front of the body and the other two at the left and right sides of the rear of the body. Each human sensor 21 has an infrared light-receiving sensor that detects the presence of a human based on the amount of infrared light received. When the human sensor detects an irradiated object which changes the amount of infrared light received, the CPU 11 acquires the result of detection by the human sensor 21 via the bus 14 to change the status for output.

In other words, the CPU 11 acquires the status of each of the human sensors 21fr, 21rr, 21fl, and 21rl at each predetermined time and detects the presence of a human in front of the human sensor 21fr, 21rr, 21fl, or 21rl by a change in the status.

Although the human sensors described above detect the presence of a human based on changes in the amount of infrared light, the human sensors are not limited to this type. For example, if the CPU's processing capability is increased, it is possible to take a color image of a target area, identify a skin-colored area that is characteristic of a human body and detect the presence of a human based on the size of the area and/or change.

The obstacle monitoring unit 30 consists of a passive sensor unit 31 composed of ranging sensors for auto focus (hereinafter called AF) (31R, 31FR, 31FM, 31FL, 31L, 31CL); an AF sensor communication I/O 32 as a communication interface to the passive sensor unit 31; illumination LEDs 33; and an LED driver 34 to supply driving current to each LED. First, the construction of the AF passive sensor unit 31 will be described.

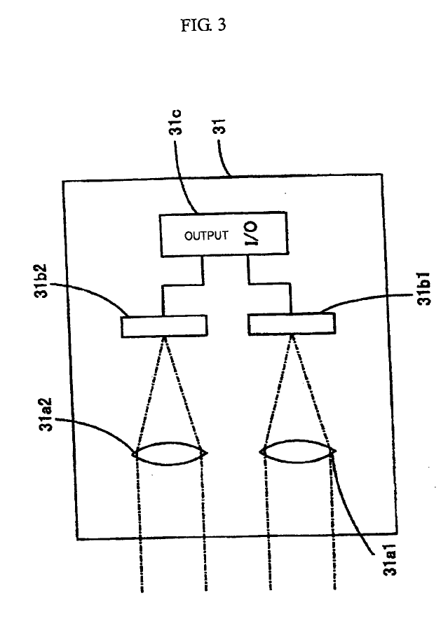

FIG. 3 schematically shows the construction of the AF passive sensor unit 31. It includes a biaxial optical system consisting of almost parallel optical systems 31a1 and 31a2; CCD line sensors 31b1 and 31b2 disposed approximately in the image focus positions of the optical systems 31a1 and 31a2 respectively; and an output I/O 31c to output image data taken by each of the CCD line sensors 31b1 and 31b2 to the outside.

CCD line sensors 31b1 and 31b2 each have a CCD sensor with 160 to 170 pixels and can output 8-bit data representing the amount of light for each pixel. Since the optical system is biaxial, the discrepancy between two formed images varies depending on the distance, which means that it is possible to measure a distance based on a difference between data from the CCD line sensors 31b1 and 31b2. As the distance decreases, the discrepancy between formed images increases, and vice versa. Therefore, an actual distance is determined by scanning data rows (4-5 pixels/row) in output image data, finding the difference between the address of an original data row and that of a discovered data row, and then referencing a difference-to-distance conversion table prepared in advance.

The AF passive sensors 31FR, 31FM, and 31FL are used to detect an obstacle in front of the cleaner while the AF passive sensors 31R and 31L are used to detect an obstacle on the right or left ahead in the immediate vicinity. The AF passive sensor 31CL is used to detect a distance up to the ceiling ahead.

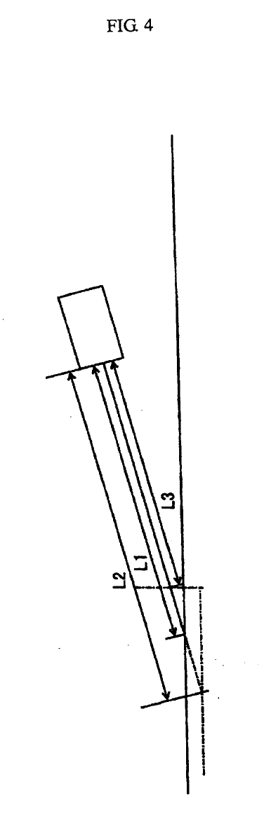

FIG. 4 shows the principle under which the AF passive sensor unit 31 detects an obstacle in front of the cleaner or on the immediate right or left ahead. The AF passive sensor unit 31 is oriented obliquely toward the surrounding floor surface. If there is no obstacle on the opposite side, the ranging distance covered by the AF passive sensor unit 31 in the almost whole imaging range is expressed by L1. However, if there is a floor level difference as indicated by alternate long and short dash line in the figure, the ranging distance is expressed by L2. Namely, an increase in the ranging distance suggests the presence of a floor level difference. If there is a floor level rise as indicated by alternate long and two dashes line, the ranging distance is expressed by L3. If there is an obstacle, the ranging distance is calculated as the distance to the obstacle as when there is a floor level rise, and it is shorter than the distance to the floor.

In this embodiment, when the AF passive sensor unit 31 is oriented obliquely toward the floor surface ahead, its imaging range is approx.10 cm. Since this self-propelled cleaner has a width of 30 cm, the three AF passive sensors 31FR, 31FM and 31FL are arranged at slightly different angles so that their imaging ranges do not overlap. This arrangement allows the three AF passive sensors 31FR, 31FM and 31FL to detect an obstacle or floor level difference in a 30 cm wide area ahead of the cleaner. The detection area width varies depending on the sensor model and position, and the number of sensors should be determined according to the actually required detection area width.

Regarding the AF passive sensors 31R and 31L which detect an obstacle on the immediate right and left ahead, their imaging ranges are vertically oblique to the floor surface. The AF passive sensor 31R is mounted at the left side of the body so that a rightward area beyond the width of the body is shot across the center of the body from the immediate right and the AF passive sensor 31L is mounted at the right side of the body so that a leftward area beyond the width of the body is shot across the center of the body from the immediate left.

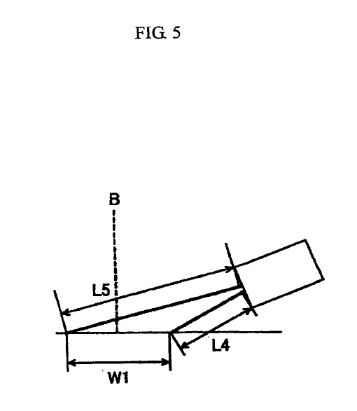

If the left and right sensors should be located so as to cover the leftward and rightward areas just before them respectively, they would have to be sharply angled with respect to the floor surface and the imaging range would be very narrow. As a consequence, more than one sensor would be needed on each side. For this reason, the left and right sensors are arranged to cover the rightward and leftward areas respectively in order to obtain a wider imaging range with a smaller number of sensors. The CCD line sensors are arranged vertically so that the imaging range is vertically oblique, and as shown in FIG. 5, the imaging range width is expressed by W1. Here, L4, distance to the floor surface on the right of the imaging range, is short and L5, distance to the floor surface on the left, is long. The imaging range portion up to the border line is used to detect a floor level difference or the like and the imaging range portion beyond the border line is used to detect a wall, where the border line of the body side is expressed by dashed line B in the figure.

The AF passive sensor 31CL, which detects a distance to the ceiling ahead, faces the ceiling. Usually, the distance from the floor surface to the ceiling which is detected by the AF passive sensor 31CL is constant but as it comes closer to a wall surface, it covers not the ceiling but the wall surface and the ranging distance becomes shorter. Hence, the presence of a wall can be detected more accurately.

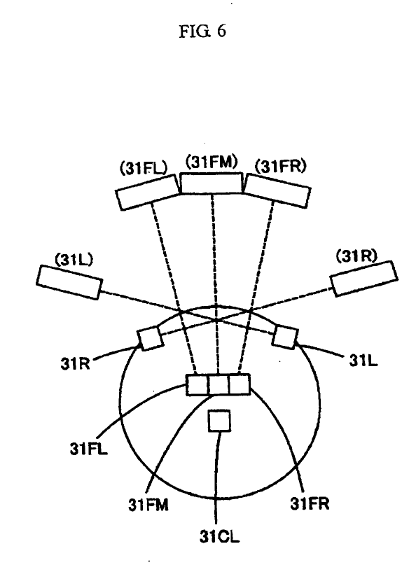

FIG. 6 shows how the AF passive sensors 31R, 31FR, 31FM, 31FL, 31L and 31CL are located on the body BD where the respective floor imaging ranges covered by the sensors are represented by the corresponding code numbers in parentheses. The ceiling imaging range is omitted here.

The cleaner has the following white LEDs: a right illumination LED 33R, a left illumination LED 33L and a middle illumination LED 33M to illuminate the images from the AF passive sensors 31R, 31FR, 31FM, 31FL and 31L; and an LED driver 34 supplies a driving current to illuminate the images according to an instruction from the CPU11. Therefore, even at night or in a dark place (under the table, etc), it is possible to get image data from the AF passive sensor unit 31 effectively.

The traveling system unit 40 includes: motor drives 41R, 41L; driving wheel motors 42R, 42L; and a gear unit (not shown) and driving wheels driven by the driving wheel motors 42R and 42L. A driving wheel is provided on each side (right and left) of the body. In addition, a free rolling wheel without a drive source is attached to the center bottom of the front side of the body. The rotation direction and angle of the driving wheel motors 42R and 42L can be accurately controlled by the motor drivers 41R and 41L which output drive signals according to an instruction from the CPU11. From output of rotary encoders integral with the driving wheel motors 42R and 42L, the actual driving wheel rotation direction and angle can be accurately detected. Alternatively, the rotary encoders may not be directly connected with the driving wheels but a driven wheel which can rotate freely may be located near a driving wheel so that the actual amount of rotation can be detected by feedback of the amount of rotation of the driven wheel even if the driving wheel slips. The traveling system unit 40 also has a geomagnetic sensor 43 so that the traveling direction can be determined according to the earth magnetism. An acceleration sensor 44 detects the acceleration speed in the X, Y and Z directions and outputs the detection result.

The gear unit and driving wheels may be embodied in any form and they may use circular rubber tires or an endless belt to be driven.

The cleaning mechanism of the self-propelled cleaner consists of: side brushes located forward at both sides which gather dust beside each side of the body in the advance direction and bring it toward the center of the body; a main brush which scoops the gathered dust in the center; and a suction fan which takes the dust scooped by the main brush into a dust box by suction. The cleaning system unit 50 consists of: side brush motors 51R and 51L and a main brush motor 52; motor drivers 53R, 53L and 54 for supplying driving power to the motors; a suction motor 55 for driving the suction fan; and a motor driver 56 for supplying driving power to the suction motor. The CPU 11 appropriately controls cleaning operation with the side brushes and main brush depending on the floor condition and battery condition or a user instruction.

The camera system unit 60 has two CMOS cameras 61 and 62 with different viewing angles which are mounted on the front side of the body at different angles of elevation. A camera communication I/O 63 which gives the camera 61 or 62 an instruction to take a photo and outputs the photo image. In addition, it has a illumination LED for camera 64 composed of 15 white LEDs oriented toward the direction in which the cameras 61 and 62 take photos, and an LED driver 65 for supplying driving power to the LEDs.

The wireless LAN unit 70 has a wireless LAN module 71 so that the CPU 11 can be connected with an external LAN wirelessly in accordance with a prescribed protocol. The wireless LAN module 71 assumes the presence of an access point (not shown) and the access point should be connectable with an external wide area network (for example, the Internet) through a router. Therefore, ordinary mail transmission and reception through the Internet and access to websites are possible. The wireless LAN module 71 is composed of a standardized card slot and a standardized wireless LAN card to be connected with the slot. Needless to say the card slot may be connected with another type of standardized card.

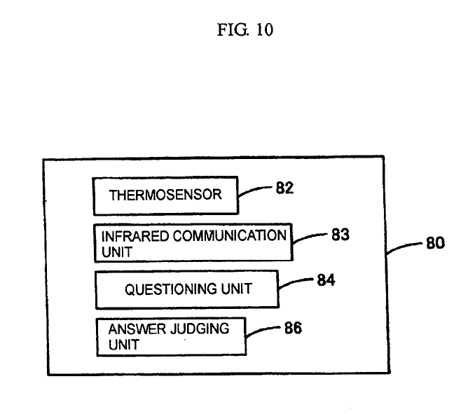

The optional unit 80 includes additional sensors and as shown in FIG. 10, in this embodiment it has a thermosensor 82, an infrared communication unit 83, a questioning unit 84 and an answer judging unit 86. The thermosensor 82 is a sensor which detects temperatures in a non-contact manner. Such sensors are connected to the bus 14 and the CPU 11 can acquire the result of detection by each sensor. The infrared communication unit 83 can receive an infrared signal as encoded positional data sent from a marker (stated later) and decode the positional data and send it to the CPU 11. The questioning unit 84 asks a cared person a question by voice using a speaker.

Here, a voice message is desirable but a siren or buzzer sound is acceptable. The answer judging unit 86 uses a microphone and gets voice or sound around it in a predetermined time after questioning and judges whether it is an answer or not.

Preferably it should have a voice recognition capability. However, it may have a simple structure to check whether or not there is voice or sound louder than a prescribed level. If the question is, for example, “Please say ‘yes’ within three seconds,” it detects the level of voice or sound heard within three seconds and judges whether voice louder than a prescribed level has been heard after silence. In order to prevent misjudgment due to ambient noise, it may be effective to provide a means to retry judgment if voice louder than a prescribed level is heard twice or more. The threshold may be changed according to the ambient noise level before asking a question.

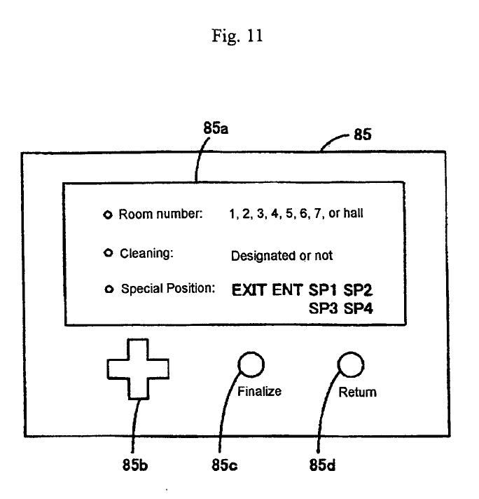

FIG. 11 shows the appearance of the marker 85 which has a liquid crystal display panel 85a, a cross key 85b, an Finalizing key 85c and a Return key 85d on its external face. Inside it are a one-chip microcomputer, an infrared transmission/reception unit, a battery and so on. The one-chip microcomputer controls the display content on the liquid crystal display panel 85a according to the operation of the Finalizing key 85c or Return key 85d and generates parameters in response to key operation to allow the infrared transmission/reception unit to output positional data depending on the parameters. In this embodiment, the following parameters are available: room numbers “1 to 7 or hall”; cleaning “yes” and “no”; and special positions “EXIT” (exit), “ENT” (entrance), “SP1” (special position 1), “SP2” (special position 2), “SP3” (special position 3), and “SP4” (special position 4). In the embodiment below, special positions 1, 2, 3, and 4 respectively represent a first, a second, a third, and a fourth cared person. A flowchart required to specify these parameters does not require special expertise and can be prepared by a person with ordinary knowledge in the art.

Next, how the above self-propelled cleaner works will be described.

(1) Travel Control and Cleaning Operation

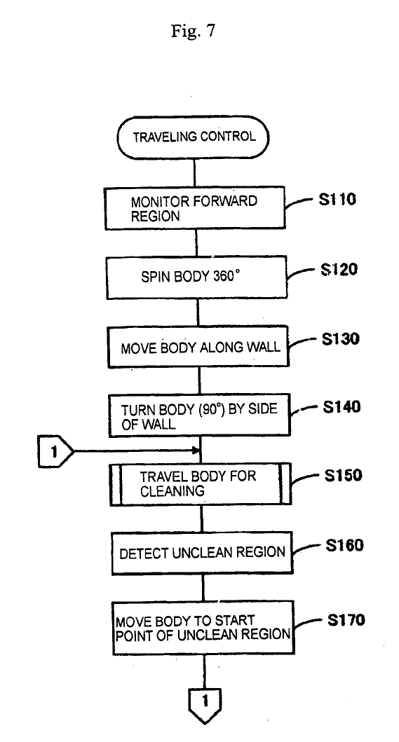

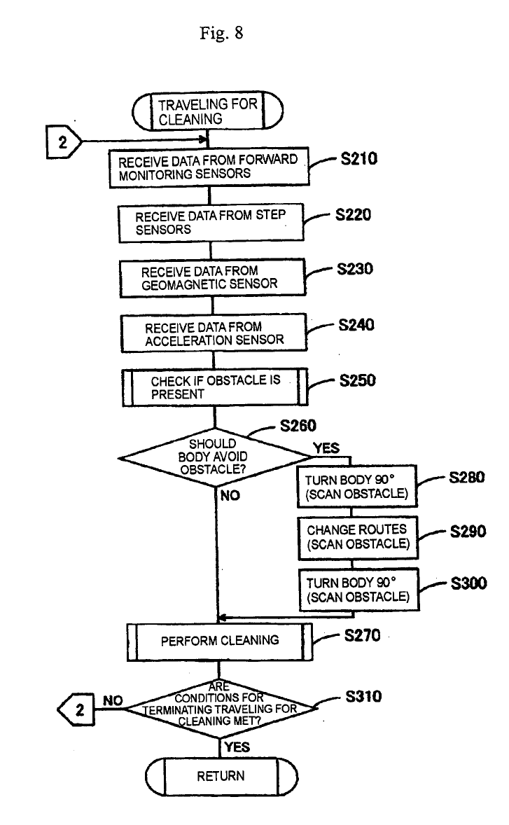

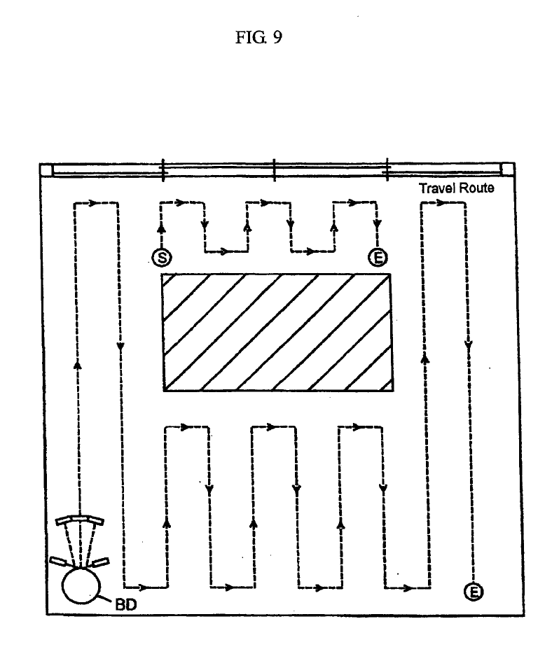

FIGS. 7 and 8 are flowcharts which correspond to a control program which is executed by the CPU 11; and FIG. 9 shows a travel route on which this self-propelled cleaner moves under the control program.

When the power is turned on, the CPU 11 begins travel control as shown in FIG. 7. At step S110, it receives the results of detection by the AF passive sensor unit 31 and monitors a forward region. In monitoring the forward region, reference is made to the results of detection by the AF passive sensors 31FR, 31FM and 31F; and if the floor surface is flat, the distance L1 to the floor surface (located downward in an oblique direction as shown in FIG. 4) is obtained from an image thus taken. Whether the floor surface in the forward region corresponding to the body width is flat or not is decided based on the results of detection by the AF passive sensors 31FR, 31FM and 31FL. However, at this moment, no information on the space between the body's immediate vicinity and the floor surface areas facing the AF passive sensors 31FR, 31FM and 31FL is not obtained so the space is a dead area.

At step S120, the CPU 11 orders the driving wheel motors 42R and 42L to rotate in different directions by equal amount through the motor drivers 41R and 41L respectively. As a consequence, the body begins turning on the spot. The rotation amount of the drive motors 42R and 42L required for 360-degree turn (spin turn) on the same spot is known and the CPU 11 informs the motor drivers 41R and 41L of that required rotation amount.

During this spin turn, the CPU 11 receives the results of detection by the AF passive sensors 31R and 31L and judges the condition of the immediate vicinity of the body. The above dead area is almost covered (eliminated) by the results of detection obtained during this spin turn, and if there is no floor level difference or obstacle there, it is confirmed that the surrounding floor surface is flat.

At step 130, the CPU 11 orders the driving wheel motors 42R and 42L to rotate by equal amount through the motor drivers 41R and 41L respectively. As a consequence, the body begins moving straight ahead. During this straight movement, the CPU 11 receives the results of detection by the AF passive sensors 31FR, 31FM and 3FL and the body advances while checking whether there is an obstacle ahead. The above dead area is almost covered by the detection made during this spin turn. When a wall surface as an obstacle ahead is detected, the body stops short of the wall surface by a prescribed distance.

At step S140, the body turns clockwise by 90 degrees. The prescribed distance short of the wall at step S130 corresponds to a, distance that the body can turn without colliding against the wall surface and the AF passive sensors 31R and 31L can monitor their immediate vicinity and rightward and leftward areas beyond the body width. In other words, the distance should be such that when the body turns 90 degrees at step S140 after it stops according to the results of detection by the AF passive sensors 31FR, 31FM and 31FL at step S130, the AF passive sensor 31L can at least detect the position of the wall surface. Before it turns 90 degrees, the condition of its immediate vicinity should be checked according to the results of detection by the AF passive sensors 31R and 31L. FIG. 9 is a plan view which shows the cleaning start point (in the left bottom corner of the room as shown) which the body has thus reached.

There are various other methods of reaching the cleaning start point. If the body should turn only clockwise 90 degrees in contact with the wall surface, cleaning would begin midway on the first wall. If the body reaches the optimum position in the left bottom corner as shown in FIG. 9, it is also desirable to control its travel so that it turns counterclockwise 90 degrees in contact with the wall surface and advances until it touches the front wall surface, and upon touching the front wall surface, it turns 180 degrees.

At step S150, the body travels for cleaning. FIG. 8 is a flowchart which shows cleaning travel steps in detail. Before advancing or moving forward, the CPU 11 receives the results of detection by various sensors at steps S210 to S240. At step S210, it receives forward monitor sensor data (specifically the results of detection by the AF passive sensors 31FR, 31FM, 31FL and 31CL) which is used to judge whether or not there is an obstacle or wall surface ahead in the traveling area. Forward monitoring here includes monitoring of the ceiling in a broad sense.

At step S220, the CPU 11 receives floor level difference sensor data (specifically the results of detection by the AF passive sensors 31R and 31L) which is used to judge whether or not there is a floor level difference in the immediate vicinity of the body in the traveling area. Also, while the body moves along a wall surface or obstacle, the distance to the wall surface or obstacle is measured in order to judge whether or not it is moving in parallel with the wall surface or obstacle.

At step 230, the CPU 11 receives geomagnetic sensor data (specifically the result of detection by the geomagnetic sensor 43) which is used to judge whether or not there is any change in the traveling direction of the body which is moving straight. For example, the angle of earth magnetism at the cleaning start point is memorized and if an angle detected during traveling is different from the memorized angle, the amounts of rotation of the left and right driving wheel motors 42R and 42L are slightly differentiated to correct the moving direction to restore the original angle. If the angle becomes larger than the original angle of earth magnetism (change from 359 degrees to 0 degree is an exception), it is necessary to correct the moving direction leftward. Hence, an instruction is given to the motor drivers 41R and 41L to make the amount of rotation of the right driving wheel motor 42R slightly larger than that of the left driving wheel motor 42L.

At step S240, the CPU 11 receives acceleration sensor data (specifically the result of detection by the acceleration sensor 44) which is used to check the traveling condition. For example, if the direction of acceleration is almost constant just after start of straight movement, it is thought to suggest a normal travel, but if a change in the direction of acceleration is detected, it is suspected that one driving wheel motor is not driven. If a detected acceleration velocity is out of the normal range, a fall from a bump or an overturn is suspected. If a considerable backward acceleration is detected, collision against an obstacle ahead is suspected. Although there is no direct acceleration control function (for example, a function to keep a desired acceleration velocity by input of an acceleration value or achieve a desired acceleration velocity based on integration), acceleration data is effectively used to detect an abnormality.

At step S250, the presence of an obstacle is judged based on the results of detection by the AF passive sensors 31FR, 31FM, 31CL, 31FL, 31R and 31L which the CPU 11 have received at steps S210 and S220. An obstacle judgment is made for each subarea of the forward region, ceiling and immediate vicinity. Here the forward region refers to an area ahead where detection for an obstacle or wall surface is made; and the immediate vicinity refers to an area where detection for a floor level difference is made or the condition of areas on the left and right of the body beyond the traveling width is checked (presence of a wall, etc). The ceiling here refers to an area where a detection is made, for example, for a door lintel underneath the ceiling which leads to a hall and might cause the body to go out of the room.

At step S260, the system evaluates the results of detection by the sensors comprehensively to decide whether to escape or not. As far as it is unnecessary to escape, a cleaning process at step S270 is carried out. The cleaning process refers to a process that dust is sucked in while the side brushes and main brush are rotating. Concretely, an instruction is issued to the motor drivers 53R, 53L, 54 and 56 to drive the motors 51R, 51L, 52 and 55. Obviously the same instruction is always given during traveling and when the conditions to end cleaning travel are met, the body stops traveling.

On the other hand, if it is decided that the body should escape, it turns clockwise 90 degrees at step S280. This is a 90-degree turn on the same spot which is achieved by giving an instruction to the driving wheel motors 42R and 42L through the motor drivers 41R and 41L respectively to turn in different directions by the amount necessary for the 90-degree turn. Here, the right driving wheel should turn backward and the left driving wheel should turn forward. During the turn, the CPU 11 receives the results of detection by the AF passive sensors 31R and 31L as floor level difference sensors and checks for an obstacle. When an obstacle ahead is detected and the body turns clockwise 90 degrees, if the AF passive sensor 31R does not detect a wall ahead on the right in the immediate vicinity, it may be considered to have simply touched a forward wall, but if a wall surface ahead on the right in the immediate vicinity is still detected even after the turn, the body may be considered to be caught in a corner. If neither of the AF passive sensors 31R and 31L detects an obstacle ahead in the immediate vicinity during 90-degree turn, it can be thought that the body has not touched a wall but there is a small obstacle.

At step S290, the body advances to turn while scanning for an obstacle. It touches the wall surface and turns clockwise 90 degrees, then advances. If it has stopped short of the wall, the distance of the advance is almost equal to the body width. After advancing that distance, the body turns clockwise 90 degrees again.

During the above movement, the forward region and leftward and rightward areas ahead are always scanned for an obstacle and the result of this monitoring scan is memorized as information on the presence of an obstacle in the room.

As explained above, a 90-degree clockwise turn is made twice. If the body should turn clockwise 90 degrees upon detection of a next wall ahead, it would return to its original position. Therefore, after it turns clockwise 90 degrees twice, it should turn counterclockwise twice and after that, counterclockwise, namely in alternate directions. This means that it should turn clockwise at an odd-numbered time of escape motion and counterclockwise at an even-numbered time of escape motion.

The system continues traveling for cleaning while scanning the room in a zigzag pattern and avoiding an obstacle as described so far. Then at step S310, whether or not it has reached the end of the room is decided. When, after the second turn, the body has advanced along the wall and has detected an obstacle ahead, or when it enters an area where it has already traveled, it is decided that the body has reached the cleaning travel end point. In other words, the former situation is a condition which occurs after the last end-to-end travel in the zigzag movement; and the latter situation is a condition that an area left uncleaned is found and cleaning travel is started again.

If either of these conditions is not met, the system goes back to step S210 and repeats the abovementioned steps. If either of the conditions is met, the system finishes the cleaning travel subroutine and returns to the process of FIG. 7. After returning to the process of FIG. 7, at step S160, the system judges from the collected information on the travel route and its surroundings as to whether or not there is any area left uncleaned. If an uncleaned area is found, the body moves to the start point of the uncleaned area at step S170 and the system returns to step S150 and starts cleaning travel again. Even if there are more than one uncleaned area here and there, each time a condition to end cleaning travel is met, detection for an uncleaned area is repeated as described above until there is no uncleaned area.

(2) Mapping

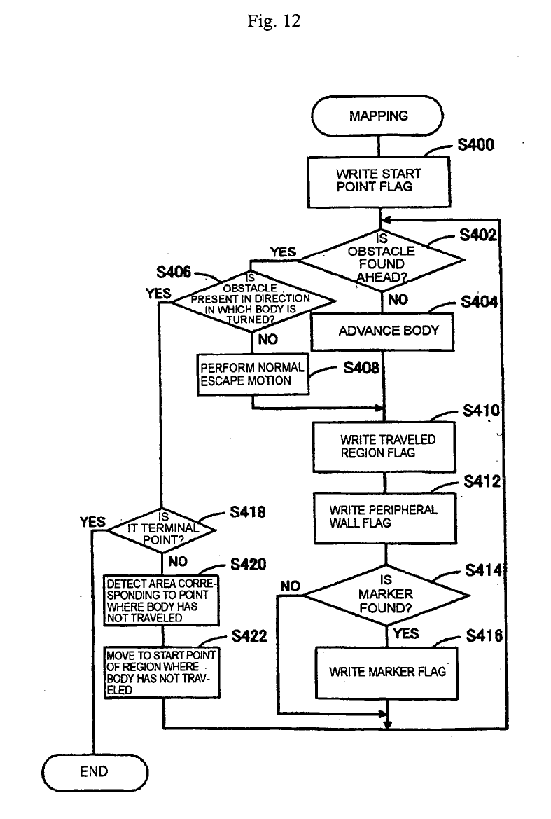

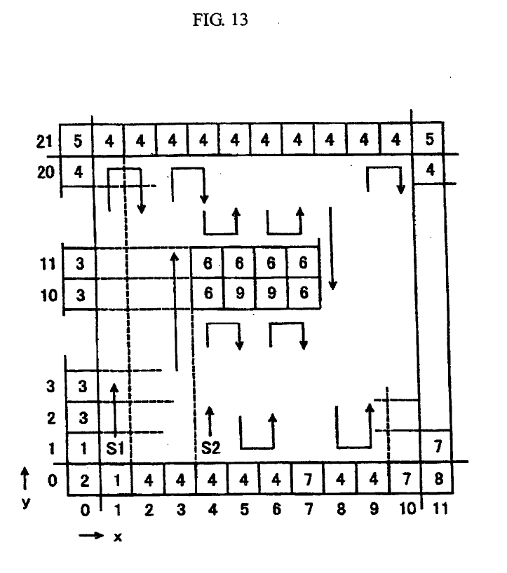

Various methods of detection for an uncleaned area are available. This embodiment adopts a method as illustrated in FIGS. 12 and 13.

FIG. 12 is a flowchart of mapping and FIG. 13 illustrates a mapping method. In this example, based on the abovementioned rotary encoder detection results, the travel route in the room and information on wall surfaces detected during travel are written in a map reserved in a memory area. The presence of an uncleaned area is determined depending on whether or not the surrounding wall surface is continuous and the areas around obstacles in the room are all continuous and the body has traveled across all areas of the room except the obstacles.

The mapping database is a two-dimensional database which allows an address to be expressed as (x, y) where (1, 1) denotes the start point in a corner of the room and (n, 0) and (0, m) denote hypothetical wall surfaces. As the body travels, the room is mapped by categorizing its subareas into several groups: uncovered areas, cleaned areas, walls and obstacles where each subarea is a unit area whose dimensions are equal to the body's dimensions, or 30 cm×30 cm.

At step S400, a start point flag is written. The start point (1, 1) is a corner of the room as shown in FIG. 13. The body turns 360 degrees (spin turn) and confirms that there is a wall surface behind and on the left of it; and the system writes a wall flag [1] for unit areas (1,0) and (0,1) and writes a wall flag [2] for an intersection of walls (0,0). At step S402, the body judges whether or not there is an obstacle ahead and at step S404, it advances by the distance equivalent to a unit area. This advance involves cleaning as mentioned above. Concretely, when an advance by a unit area distance is indicated by rotary encoder output during cleaning travel, this mapping process is performed synchronously.

On the other hand, if it is decided that there is an obstacle ahead, whether there is an obstacle in the direction of turn is judged at step S406. The body escapes from the obstacle by a combination of a 90-degree turn, an advance and a 90-degree turn. The direction of turn is alternately changed every two turns (two clockwise turns, then two counterclockwise turns). If the next turn for escape should be clockwise and there is an obstacle ahead, whether or not the body can go rightward and turn is judged. In the early stage of cleaning, on the assumption that the rightward area is uncleaned and there is no obstacle in the direction of turn, normal escape motion is done at step S408.

After the above movements, at step S410, a covered subarea flag is written for each unit area where the body has traveled. Since an area where the body has traveled (covered area) is considered to be an area which has been cleaned, a flag which represents a cleaned area is written for it. At step S412, a peripheral wall flag which represents the condition of a peripheral wall is written in each unit area. When the body moves from unit area (1,1) to unit area (1,2), it is possible to judge whether unit areas (0,1) and (2,1) are a wall or not according to the results of detection by the AF passive sensors 31R and 31L. A flag which represents a wall is written for unit area (0,1) and a flag which represents the absence of a wall and an uncovered/uncleaned area is written for unit area (2,1).

In this example, an obstacle ahead is detected at the position of unit area (1,20) and the body moves to unit area (2,20) by two 90-degree turns and an advance while the traveling direction is changed 180 degrees. At this time, a flag [4] is written for each of unit areas (0,20), (2,20), (1,21) and (2,21) For unit area (0,21), a flag which represents a wall [5] is written based on the judgment that it is an intersection of walls. A covered/cleaned area is also treated as an obstacle.

As the body advances, an obstacle on the right is detected at the positions of unit areas (3,10) and (3,11) and a flag for an obstacle [6] is written. While the body moves across unit areas (3,1) to (3, 9), uncovered/uncleaned areas ahead on the right are detected and a corresponding flag is written for them. Similarly, when the body moves across unit areas (8,9) to (8,1) later, uncovered/uncleaned areas ahead on the right are detected and a corresponding flag is written for them.

When the body is at the position of unit area (4,12), an obstacle ahead is detected and an escape motion is done. Here, an obstacle flag has been written for unit area (4,11) and as it moves, an obstacle flag is written for unit area (4,11).

At step S414, whether or not there has been communication of positional data with the marker 85 is judged at the position of each covered unit area; if there has been communication with the marker 85, a flag based on the marker information is written at step S416. For example, if the user has specified a particular unit area for an escape gate using operation keys 85b to 85d of the marker 85, as the body passes the unit area, the infrared communication unit 83 acquires that positional data and a flag representing an escape gate is written for that unit area.

After repeated advance and escape motions, an obstacle ahead on the left is detected at the position of unit area (10,20) In this case, unit area (10,20) is judged as a continuous wall and a wall flag [4] is also written for unit area (11, 20) and a wall intersection flag [5] is written for unit area (11, 21).

As a result of repeated advance and escape motions, an obstacle ahead is detected at the position of unit area (10,1) and an obstacle in the direction of turn is also detected. Hence, whether the travel end is reached or not is judged at step S418. At the position of unit area (10,1), an obstacle ahead and a wall on the left in the traveling direction are detected [7] [8].

A primary factor which determines whether the travel end has been reached or not is the presence or absence of a unit area for which an “uncovered/uncleaned” area flag is written. If there is no unit area for which an uncovered/uncleaned area flag is written, whether or not the wall flag written at the start point is continuously repeated to go round the room is checked. If so, the room is scanned in both the X and Y directions to check for an area for which no flag is written. Unit areas for which an obstacle flag is written are considered as a continuous area like a wall and obstacle detection is thus finished.

If the cleaning travel end has not been reached, an uncovered area is detected at step S420 and the body moves to the start point of that uncovered area at step S422 and the above process is repeated. When it is finally decided that the cleaning travel end has been reached, mapping is completed. Upon completion of mapping, the walls and covered areas of the room are clearly indicated and this is used as geographical information.

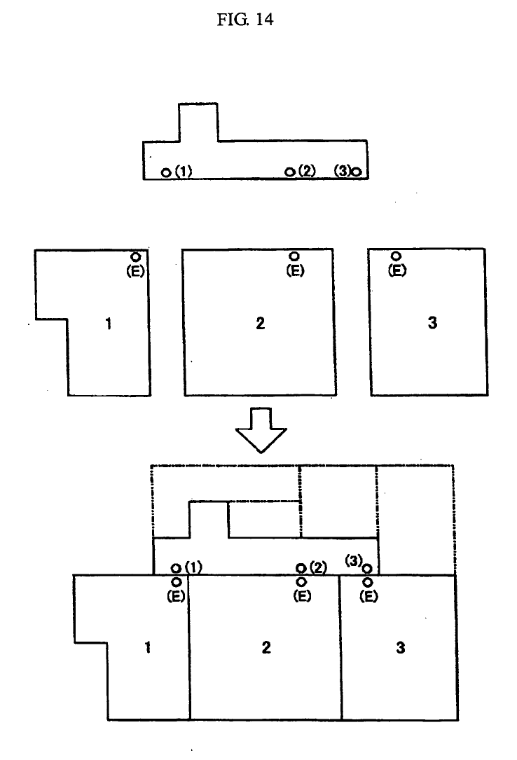

All rooms and halls should be mapped with the abovementioned procedure and entrances to rooms in halls should be marked via the marker 85. FIG. 14 shows a method of interlinking geographical information on rooms and halls. All rooms are numbered (1-3) and entrances/exits (E) and approaches to rooms from halls (1-3) are marked so that geographical information on rooms is two-dimensionally interlinked.

(3) Nursing Patrol Programming

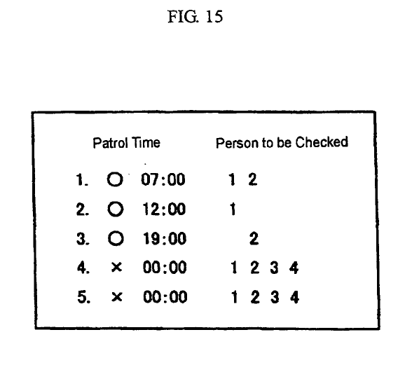

FIG. 15 shows a screen where patrol time and cared persons are specified.

Using the operation switches 15a and the liquid crystal display panel 15b, the user specifies what time to patrol and which cared person (location) to be reached at each patrol time. Up to five patrol times can be set and cared persons' locations are designated as special positions SP1 to SF4 via the marker 85. In the figure, ◯ (yes) and X (no) respectively denote that the cared person(s) should be checked or not at a particular patrol time. In the example of FIG. 15, programming is done so that a caregiver goes to the first and second persons at 07:00, then to the first person at 12:00 and then to the second person at 19:00. Needless to say, the system has a clock function for patrol time programming.

A program for specifying patrol times and cared persons is executed according to a flowchart which can be prepared by a person with an ordinary skill in the art.

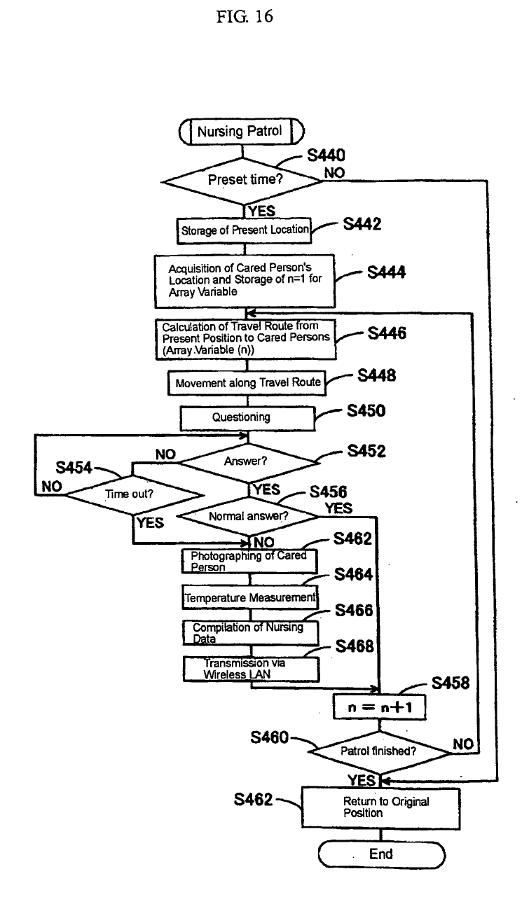

FIG. 16 is a flowchart of a nursing patrol process.

As this process is started upon receipt of a user instruction given via the operation panel unit 15, the system compares the present time with a preset time on the timer at step S442 and decides whether it is the preset time or not; if so, the following steps are taken.

At step S442, the present location is memorized so that the body can return to the present position after going to the last cared person.

At step S444, the system acquires data on the location of a cared person to be checked and memorizes it for an array variable. If it is 7 o'clock, the first and second persons should be checked as shown in FIG. 15. Hence, the system acquires data on the locations of the two persons and memorizes it for an array variable. This enables programming for sequential patrol where the variable is expressed by n. Therefore, “1” is set for variable n.

At step S446, the system calculates a travel route from the present position to the n-th cared person as memorized as an array variable.

When geographical information is completed as described above, it is possible to find the travel route from the present position to the n-th cared person. To obtain the travel route, a known labyrinth solution method may be used. For example, according to the right hand method, when you advance constantly with your hand on a wall surface along the advance direction, you can finally reach from the entrance to the goal. Then, redundant paths are deleted sequentially. For example, return paths after 180-degree turns are deleted sequentially. Also, a subarea of U turn is found and subareas as a return path after the U turn are skipped unless there is an obstacle. Instead of an automatic travel route calculation like this, an interface which shows the user a travel route may be provided.

After the travel route from the present position to the cared person is calculated in this way, the body moves along the travel route at step S448. After completion of the movement, the questioning unit 84 issues a question at step S450. Various questions may be issued and one example is “We are patrolling. Please say ‘yes’ within 5 seconds if you have no problem.” At step S452, the system waits for an answer and if there is an answer before time runs out (within 5 seconds in this case) at step S454, whether or not the answer is normal is judged at step S456. The answer judging unit 86 makes this judgment by voice recognition or depending on whether there is a voice or sound louder than a prescribed level. If it is possible to distinguish a snoring or sleep-breathing, it may be considered an answer. For voice recognition, sounds of snoring and sleep-breathing should be entered previously and if a sound coming through a microphone is judged as snoring or sleep-breathing by comparison with the previously entered sounds, it is considered a normal answer.

If the answer is normal, variable n is incremented at step S458 and at step S460 the system judges whether or not to end the patrol, depending on the value of the variable. If the value is larger than the number of cared persons' locations obtained at step S444, the patrol is completed and the body returns to the first position memorized at step S442. If the patrol is not completed, the system returns to step S446 and calculates a travel route from the present position at that time to the next cared person's location.

If the answer is not normal or time runs out, a photo of the cared person is taken at step S462. The camera system unit 60 is used for photographing. The CPU 11 orders the CMOS cameras 61 and 62 through the bus 14 and camera communication I/O 63 to take a photo and acquires photo image data through the communication I/O 63. The thermosensor 82 measures the temperature of the cared person in a non-contact manner. This temperature data is not always accurate but may be useful information on the cared person.

At step S466, nursing data is compiled. Nursing data includes time, cared person location data, photo image data and measured temperature. A voice taken as an answer may be subjected to digital sampling and added as voice data to nursing data.

This nursing data is sent from the wireless LAN module 71 of the wireless LAN unit 70 to a given destination at step S468. A default destination may be a preset e-mail address. If a caregiver's cellular phone e-mail address has been previously entered, the caregiver can easily know away from home such a situation that the cared person has not answered a question. If the caregiver also receives a photo image, he/she can decide whether to call for an ambulance or immediately go home. If an answer as voice data is attached, the caregiver can analyze the situation based on the voice data and an unnecessary call for an ambulance can be avoided.

FIG. 16 shows a nursing patrol process on the assumption that the first cared person is located in room 3 and the second cared person in room 2 and the body usually stands by in a hall.

As described above, whether it is a preset time or not is decided at step S440. At step S446, the system calculates the travel route from the standby position to the first cared person's location and at step S448, the body goes to that location and asks a question and judges the answer (steps S450 to S458). If the answer is normal, the travel route from the first cared person's location to the second cared person's is calculated at step S446 and the body goes to the second cared person's location at step S448 and the system asks a question and judges the answer (steps S450 to S458). If the answer is not normal at a cared person's location, nursing data on that person is compiled at steps S462 to S466 and transmitted through the wireless LAN at step S468.

When the process at the second cared person's location is finished, the body returns to the original standby position in the hall at step S462. For the purpose of this invention, “geographical information” on a room means not merely geographical information on one room but floor plan information including information on rooms and halls. This invention may also be applied to a building which is divided into plural zones.

To effectively use the self-propelling function, the location of the designated cared person is patrolled, and confirmation of whether there is an abnormality of not is made possible.

1. A self-propelled cleaner having a body with a cleaning mechanism and a drive mechanism with driving wheels at the left and right sides of the body whose rotation can be individually controlled for steering and driving the cleaner, comprising:
a mapping processor which stores geographical information on a room to be cleaned during traveling around the room for cleaning it and acquires data on the location of a cared person during traveling around the room, from a marker which is installed in a given place in the room and outputs positional data on a previously specified location, and adds it to the geographical information;
a nursing patrol control processor which, at each predetermined time, acquires data on the cared person's location specified in the geographical information and controls the drive mechanism to enable the cleaner to travel from the present position to the cared person;
a wireless LAN communication device which can transmit given information to the outside through a wireless LAN;
a questioning control processor which asks the cared person a question by voice through a speaker when the cared person is reached under the control of the nursing patrol control processor, and waits for an answer to the question from the cared person;
an answer judgment control processor which receives a spoken answer to the question from the cared person through a microphone and judges whether it is normal or not; and
a nursing data transmission control processor which, if the answer is not normal, transmits that information to the outside through the wireless LAN communication device.

2. A self-propelled cleaner having a body with a cleaning mechanism, and a drive mechanism capable of steering and driving the cleaner, comprising:
a mapping processor which stores geographical information on a room to be cleaned;
a nursing patrol control processor which, at each predetermined time, controls the drive mechanism based on a cared person's location specified in the geographical information to enable the cleaner to travel from the present position to the cared person;
a wireless LAN communication device which can transmit given information to the outside through a wireless LAN;
a questioning control processor which asks the cared person a question at a given location, and waits for an answer to the question from the cared person;
an answer judgment control processor which judges whether an answer to the question from the cared person is normal or not; and
a nursing data transmission control processor which, if the answer is not normal, transmits that information to the outside through the wireless LAN communication device.

3. The self-propelled cleaner as described in claim 2, wherein the mapping processor acquires, from a marker installed in a given place in the room which outputs positional data on a previously specified location, that positional data and adds it to the geographical information.

4. The self-propelled cleaner as described in claim 2, wherein it has a camera device for taking a photo of a surrounding area and if the answer is not normal, the nursing data transmission control processor enables the camera device to take a photo and transmits that photo image data to the outside through the wireless LAN communication device.

5. The self-propelled cleaner as described in claim 4, wherein the nursing data transmission control processor detects a skin color area in the photo image data, judges the cared person's health condition from a prepared table of relations between skin color hues and health conditions and transmits information on the result of the judgment to the outside through the wireless LAN communication device.

6. The self-propelled cleaner as described in claim 2, wherein it has a thermosensor capable of measuring a temperature in a non-contact manner and the nursing data transmission control processor enables the thermosensor to measure the temperature of the cared person and transmits the measured temperature to the outside through the wireless LAN communication device.

7. The self-propelled cleaner as described in claim 2, wherein the questioning control processor issues a question by voice through a speaker and the answer judgment control processor gets an answer spoken by the cared person through a microphone.

8. The self-propelled cleaner as described in claim 7, wherein if the voice received through the microphone is snoring or sleep-breathing, the answer judgment control processor judges it as a normal answer.

9. The self-propelled cleaner as described in claim 2, wherein the nursing patrol control processor has an operation panel unit comprising operation switches for specifying patrol time and a cared person to be checked and a liquid crystal display panel, and a clock function, and the liquid crystal display panel shows patrol times and which cared person to be reached at each patrol time according to operation of the operation switches.

10. The self-propelled cleaner as described in claim 2, wherein the nursing patrol control processor:
compares the present time with a preset time on a timer to judge whether it is the preset time, and if it is the preset time, memorizes the present position so as to enable the cleaner to return to the present position after travel to the cared person; and then,
acquires information on the location of the cared person to be checked and stores it for an array variable to enable the cleaner to reach and check cared persons sequentially according to variable n, and increments variable n sequentially to calculate a travel route from the present position to the n-th cared person's location stored for the array variable.

11. The self-propelled cleaner as described in claim 2, wherein the nursing patrol control processor comprises:
a mapping processor which generates and stores geographical information on a room during traveling around the room by self-propulsion, and acquires, from a marker installed in a given place in the room which outputs positional data on a previously specified location, the positional data and adds it to the geographical information;
a travel route calculation processor which calculates a travel route from the present position to the position specified as the special position; and
a movement control processor which enables the travel route calculation processor to calculate a travel route and controls the drive mechanism to let the cleaner move along the travel route to the special position.

12. The self-propelled cleaner as described in claim 2, wherein the nursing patrol control processor has, on the body, a wall sensor for detecting a surrounding wall surface, and can receive the result of detection by the wall sensor and control the drive mechanism to let the cleaner move along the wall, and acquires positional data from a marker installed along the wall which outputs positional data, and judges whether movement to the position concerned has been completed or not.
